(19) United States
(12) Patent Application Publication
(10) Pub. No.: US 2014/0346961 A1
(43) Pub. Date: Nov. 27, 2014

(54) HIGH-WATTAGE CERAMIC METAL HALIDE LAMP

(71) Applicant: Iwasaki Electric Co., Ltd., Tokyo (JP)

(72) Inventors: Masashi Iida, Gyoda City (JP); Akiyoshi Maehara, Gyoda City (JP); Makoto Ohkahara, Gyoda City (JP)

(73) Assignee: IWASAKI ELECTRIC CO., LTD., Tokyo (JP)

(21) Appl. No.: 14/345,340

(22) PCT Filed: Nov. 2, 2012
(86) PCT No.: PCT/JP2012/078532

§ 371 Date: Mar. 17, 2014

(30) Foreign Application Priority Data
Feb. 28, 2012 (JP) 2012-040831

(51) Int. Cl. H01J 61/34; H01J 61/82

(52) U.S. Cl. CPC H01J 61/34; H01J 61/827
USPC 315/189

(57) ABSTRACT

Aspects of the disclosure include a ceramic metal halide lamp in which two arc tubes are arranged electrically in series inside the same outer globe. By arranging the two arc tubes in such a way that light-emitting parts thereof do not overlap, decline in lifespan due to the heat of one arc tube causing the temperature of the other arc tube to increase and lighting failure due to an increase in lamp voltage do not occur. And by setting the distance from an electrode tip at a base side of the first arc tube to an electrode tip at a lamp-top side of the second arc tube to be equal to or less than 3.5 times the average inter-electrode distance of both arc tubes, a preferable distribution of light is implemented.

### TECHNICAL FIELD

The present invention relates to a high-wattage ceramic metal halide lamp that uses a plurality of arc tubes electrically connected in series.

### BACKGROUND ART

Ceramic metal halide lamps use a ceramic discharge vessel that is highly resistant to corrosion and heat, and therefore various luminescence metals can be used. Such ceramic metal halide lamps can provide a light source that exhibits a higher efficiency and higher color rendering than discharge lamps using a quartz discharge vessel. For this reason, recently ceramic metal halide lamps have been used for illumination lamps for factories, stores, roads and the like.

Conventionally, quartz metal halide lamps of 1 kW or higher have been used as illumination lamps for sport facilities or high ceilings. However, with the increasing demand for CO₂ reduction due to the rise in environmental awareness, the substitution of highly efficient ceramic metal halide lamps has been expected, and it has been demanded that ceramic metal halide lamps should be of high-wattage.

Generally, high-wattage ceramic metal halide lamps have an increased arc length, while ceramic discharge vessels are more sensitive to thermal shock than quartz discharge vessels. Accordingly, there may arise a problem such that ceramic discharge vessels are cracked by arc floated when being lighted in a horizontal position to cause the arc tubes to burst out.

In a high-wattage ceramic metal halide lamp, it is necessary to seal the ceramic discharge vessel with a thick conductive material in order to feed a large current. In the case where a thick conductive material is used, when it expands due to temperature increase upon lighting, the difference in coefficient of thermal expansion between the ceramic discharge vessel and the conductive material may cause a crack.

In response to the above demand, high-wattage ceramic metal halide lamps of 450 W or higher have been proposed (Patent Literature 1: WO 2006/088128 A).

On the other hand, in order to increase the light amount of a single lamp, such a lamp has been proposed that two arc tubes electrically connected in series are arranged within the outer globe and are lighted simultaneously. The light amount of this lamp is substantially twice that of a single arc tube (Patent Literature 2: JP 11-513189 W).

For example, using two general-purpose arc tubes of 360 W provides the light amount equal to that of a high-wattage ceramic metal halide lamp of a 700 W class. In addition, using the general-purpose arc tubes of 360 W advantageously eliminates a problem with cracks or flickers, which would arise in high-wattage ceramic metal halide lamps.

Moreover, for such a lamp that a plurality of arc tubes electrically connected in series are arranged in the same outer globe, methods of reducing troubles due to the heat of the other arc tube have been proposed. In these method, the arc tubes are arranged along the tube axis of the lamp, and the arc tube disposed on the lower side bears a heavier lamp load than that disposed on the upper side (Patent Literature 3: JP 02-273457 A).

### CITATION LIST

### Patent Literatures

Patent Literature 1: WO 2006/088128 A
Patent Literature 2: JP 11-513189 W
Patent Literature 3: JP 02-273457 A

### SUMMARY OF INVENTION

### Technical Problem

However, it is found out that the ceramic metal halide lamp described in Patent Literature 1 produces flickers in response to the shake or rotation of arc, when a certain arc length and luminescence metal are selected.

The ceramic discharge vessel of such a high-wattage ceramic metal halide lamp is large in size, and it is difficult to manufacture. Therefore, there also arises a problem such that a manufacturing cost increases.

The high pressure discharge lamp described in Patent Literature 2 can solve the above problem that arises in high-wattage ceramic metal halide lamps composed of a single arc tube. However, in such a ceramic metal halide lamp that the two arc tubes are electrically connected in series, since the two arc tubes are lighted while being arranged close to each other within the same outer globe, it is found that the following problems arises. Two arc tubes arranged close to each other are likely to be affected by the heat from each other, and the temperature at a site of one arc tube which is near the other arc tube becomes high. Since each arc tube is locally heated, the ceramic discharge vessel may be cracked.

When the arc tubes arranged side by side are lighted in a horizontal position, the temperature of one of the arc tubes which is positioned on the upper side is increased. Since its internal pressure and lamp voltage increase, disadvantages, such as the occurrence of the extinction, may occur.

Furthermore, the light emitted from one arc tube is blocked by the other. As a result, the uniform luminous intensity distribution is not obtained in contrast to a lamp having a single arc tube. When this lamp is installed in an instrument, the illumination nonuniformity is created on the irradiated surface.

The lamp described in the Patent Literature 3 has aimed to improve its characteristic by reducing the mutual heat influence exerted on the arc tubes when being lighted in a vertical position. Therefore, this lamp does not consider the above problem which arises when being lighted in a horizontal position, and therefore fails to solve the problem with respect to the lighting in a horizontal position. In the lamp described in the Patent Literature 3, the arc tubes are arranged side by side along the tube axis, but apart from the center of the lamp light. Therefore, when the lamp is installed in an instrument, it causes the illumination nonuniformity, so that the instrument fails to provide a desired instrument luminous intensity distribution.

Accordingly, an object of the present invention is to provide a high-wattage ceramic metal halide lamp in which two arc tubes are electrically arranged in series within the same outer globe and are lighted simultaneously.

Another object of the present invention is to, in a ceramic metal halide lamp in which two arc tubes are electrically arranged in series within the same outer globe, aim to reduce a heat influence which one arc tube exerts on the other, thereby preventing cracks and extinction due to the overheating, and to reduce the illumination nonuniformity when such a ceramic metal halide lamp is installed in an instrument.

### Solution to Problem

A ceramic metal halide lamp according to the present invention, comprises:

two arc tubes provided in a single outer globe, each of the arc tubes having a pair of electrodes therein, the two arc tubes being electrically connected in series and lighted simultaneously,

wherein when the arc tubes disposed on a base side and a lamp top side are denoted by a first arc tube and a second arc tube, respectively, an end on the lamp top side of a light-emitting part of the first arc tube is disposed closer to a base along a lamp tube axis than an end on the base side of a light-emitting part of the second arc tube, and

a distance along the lamp tube axis between an end of the electrode on the base side of the first arc tube and an end of the electrode on the lamp top side of the second arc tube is equal to or less than 3.5 times an average distance between electrodes of the first and second arc tubes.

In the ceramic metal halide lamp according to an embodiment of the present invention, the two arc tubes may be arranged substantially parallel to the tube axis.

In the ceramic metal halide lamp according to an embodiment of the present invention, the first arc tube may be disposed in a center of lamp light.

In the ceramic metal halide lamp according to an embodiment of the present invention, the first arc tube may be disposed substantially parallel to the tube axis, and the second arc tube is disposed while being inclined with respect to the tube axis.

In the ceramic metal halide lamp according to an embodiment of the present invention, the first arc tube may be disposed in a center of lamp light.

### Advantageous Effect of Invention

According to the present invention, in a ceramic metal halide lamp in which two arc tubes electrically connected in series are lighted within a single outer globe simultaneously, by setting a distance along the tube axis between the arc tubes so as to fall within a suitable range, to solve problems due to the heating of the arc tubes, for example, the extinction, the lifetime reduction, or dropout in the instrument luminous intensity distribution when such a ceramic metal halide lamp is installed in an instrument.

### BRIEF EXPLANATION OF DRAWINGS

FIG. 1 is a view showing a ceramic metal halide lamp in which two arc tubes are electrically connected in series.

FIG. 2 is a sectional view explaining the structure of each arc tube used in FIG. 1.

FIG. 3 is a view showing the instrument luminous intensity distribution of the ceramic metal halide lamp shown in FIG. 1.

FIG. 4 is a view of a ceramic metal halide lamp in which two arc tubes are electrically connected in series.

FIG. 5 is a view showing the instrument luminous intensity distribution of the ceramic metal halide lamp shown in FIG. 4.

FIG. 6 is a view showing a change in a lamp voltage of the ceramic metal halide lamp shown in FIG. 4.

FIG. 7 is a view showing a ceramic metal halide lamp according to a first embodiment of the present invention.

FIG. 8 is a view showing the instrument luminous intensity distribution of the ceramic metal halide lamp shown in FIG. 7.

FIG. 9 is a view showing a ceramic metal halide lamp according to a second embodiment of the present invention.

FIG. 10 is a view showing the instrument luminous intensity distribution of the ceramic metal halide lamp shown in FIG. 9.

FIG. 11 is a view showing a ceramic metal halide lamp according to a third embodiment of the present invention.

### DESCRIPTION OF EMBODIMENT

Hereinafter, embodiments of a ceramic metal halide lamp according to the present invention will be described, with reference to the drawings. In the drawings, the same characters are assigned to the same elements, and an overlapping explanation thereof will be omitted.

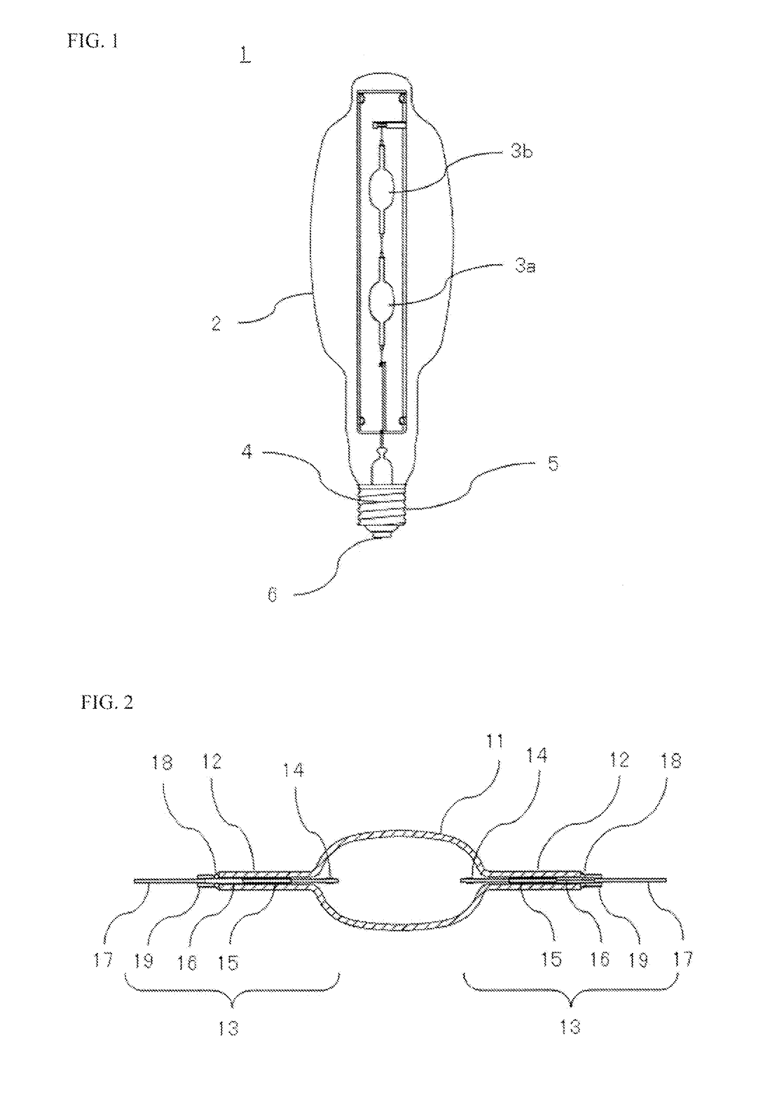

FIG. 1 is a view showing a ceramic metal halide lamp in which two arc tubes are electrically connected in series within a single outer globe. FIG. 2 is a sectional view showing each arc tube used in FIG. 1. As illustrated in a FIG. 1, a lamp 1 includes two arc tubes 3a and 3b in an outer globe 2. One lead of one of two arc tubes is connected to one lead of the other arc tube; the other leads thereof are connected to a shell 5 and eyelet 6 of a base 4, respectively. The two arc tubes are used while being lighted simultaneously.

As illustrated in FIG. 2, each of the arc tubes 3a and 3b includes a light-emitting part 11 and capillary tube parts 12 and 12 at both ends of the light-emitting part 11. Electrode mounts 13 and 13 are inserted into the capillary tube parts 12 and 12, respectively and the capillary tube parts 12 and 12 are sealed with fritted glasses. The electrode mounts 13 and 13 include respectively: tungsten electrodes 14 and 14; intermediate assemblies 15 and 15 each including a molybdenum rod and a molybdenum coil wound around the rod; conductive cermet rods 16 and 16; molybdenum external leads 17 and 17; and niobium stoppers 18 and 18. The stoppers 18 and 18 are welded to the conductive cermet rods 16 and 16, respectively so that stoppers 18 and 18 abut the ends of the capillary tube parts to hold the electrode mounts 13 and 13, respectively. Alumina reinforcing rings 19 and 19 are fixed to the circumferences of the conductive cermet rods 16 and 16 and external leads 17 and 17, as a reinforcing member for preventing this portion from being broken. The light-emitting part 11 has a substantially elliptical shape, and mercury, a rare earth halogenated compound, and rare gas are enclosed therein.

[Problems]

The ceramic metal halide lamp 1 shown in FIG. 1 is such that two arc tubes are aligned with the tube axis.

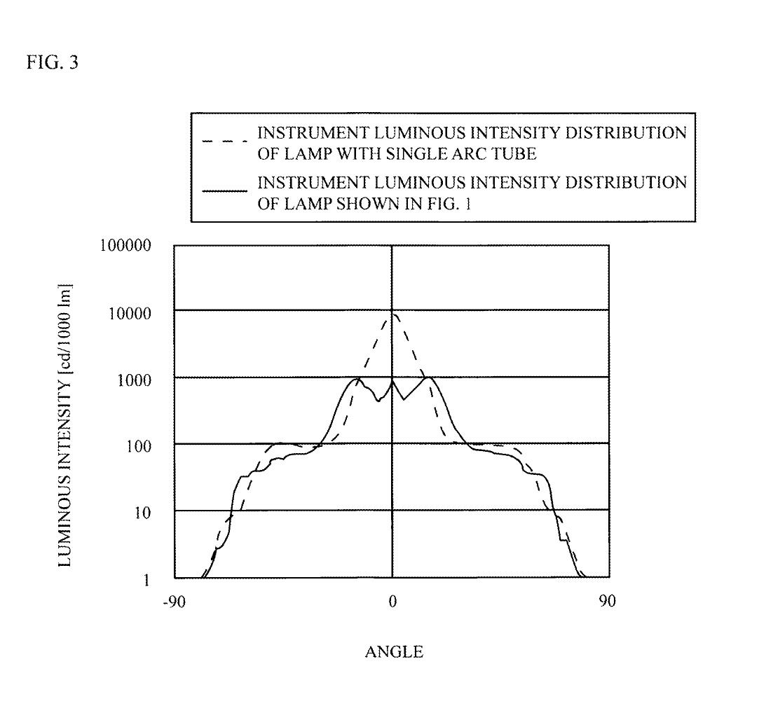

FIG. 3 is a result of comparison between a measured instrument luminous intensity distribution on a vertical plane from the ceramic metal halide 1 disposed in an illumination instrument and that of a ceramic metal halide lamp having a single arc tube, the light ceramic metal halide lamp 1 including two arc tubes aligned with the tube axis shown in FIG. 1.

The instrument luminous intensity distribution on a vertical plane was obtained by measuring light amounts of the illumination instrument at the fixed distance from the horizontal position to the downward direction. In the instrument luminous intensity distribution in the drawing, the horizontal directions with respect to the illumination instrument are denoted by 90 degrees and −90 degrees and the directly downward direction is denoted by 0 degrees.

In comparison with the instrument luminous intensity distribution of the lamp having a single arc tube, as illustrated in FIG. 3, the instrument luminous intensity distribution of the ceramic metal halide 1 of FIG. 1 exhibits a decreased luminous intensity, that is, assumes so-called a dropout state in the vicinity of the middle of the bottom (at about 0 degrees). Thus, this instrument luminous intensity distribution is not suitable. The reason is because the two arc tubes are disposed apart from the center of the lamp light, and the light from each arc tube is reflected in different directions from that specified by an instrument design.

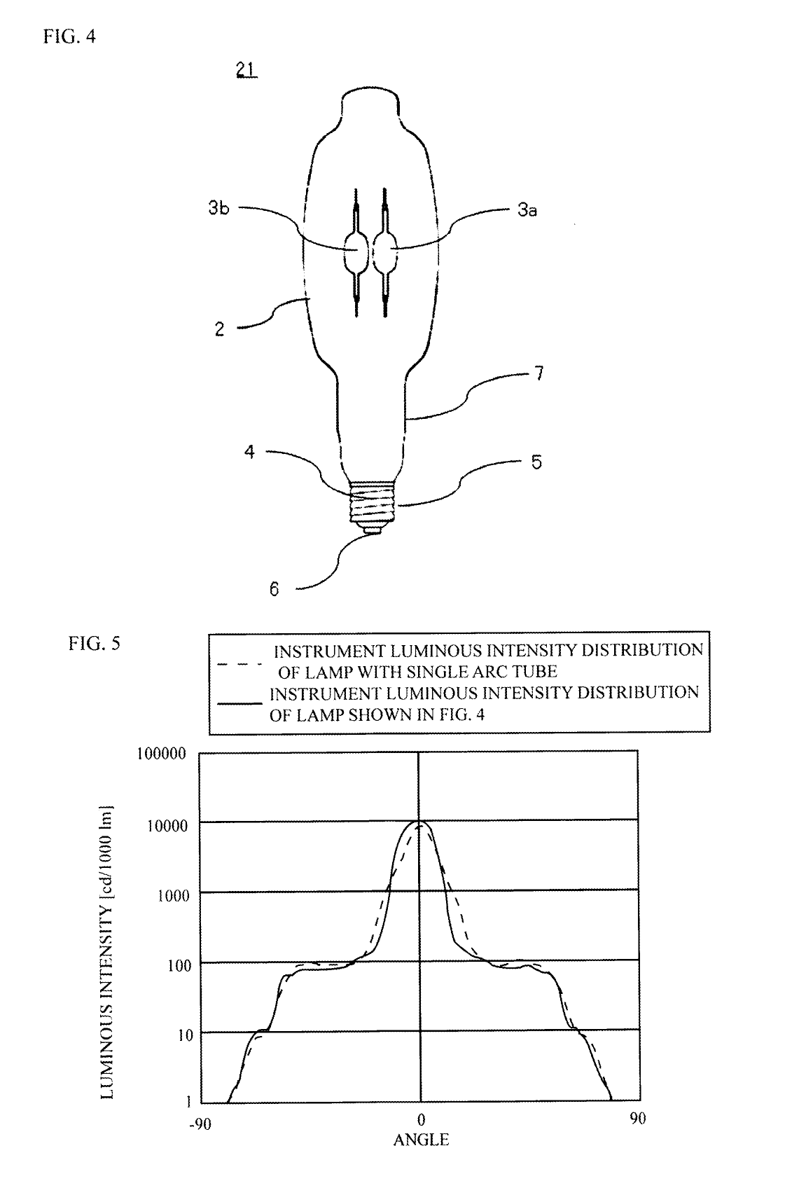

A ceramic metal halide lamp 21 shown in FIG. 4 is such that two arc tubes are arranged so that their distances from the base are aligned with the center of lamp light. In the drawings subsequent to FIG. 4, only the locations of the arc tubes arranged in the outer globe are shown, and members, including a support, are omitted, for the sake of the convenience of an explanation. FIG. 5 is a result of comparison between a measured instrument luminous intensity distribution on a vertical plane from the ceramic metal halide lamp 21 disposed in an illumination instrument and that of a ceramic metal halide lamp having a single arc tube, the ceramic metal halide lamp 21 including the two arc tubes arranged such that their distances from the base are aligned with the center of the lamp light, as shown in FIG. 4. As illustrated in FIG. 5, the ceramic metal halide lamp 21 of FIG. 4 exhibits substantially the same instrument luminous intensity distribution as the lamp having a single arc tube. In other words, the instrument luminous intensity distribution of the ceramic metal halide lamp 21 is not in the dropout state as opposed to that of the ceramic metal halide lamp of a FIG. 1, that is, is a suitable luminous intensity distribution.

However, when the ceramic metal halide lamp shown in FIG. 4 is lighted in a horizontal position, it is found out that the following problems occur.

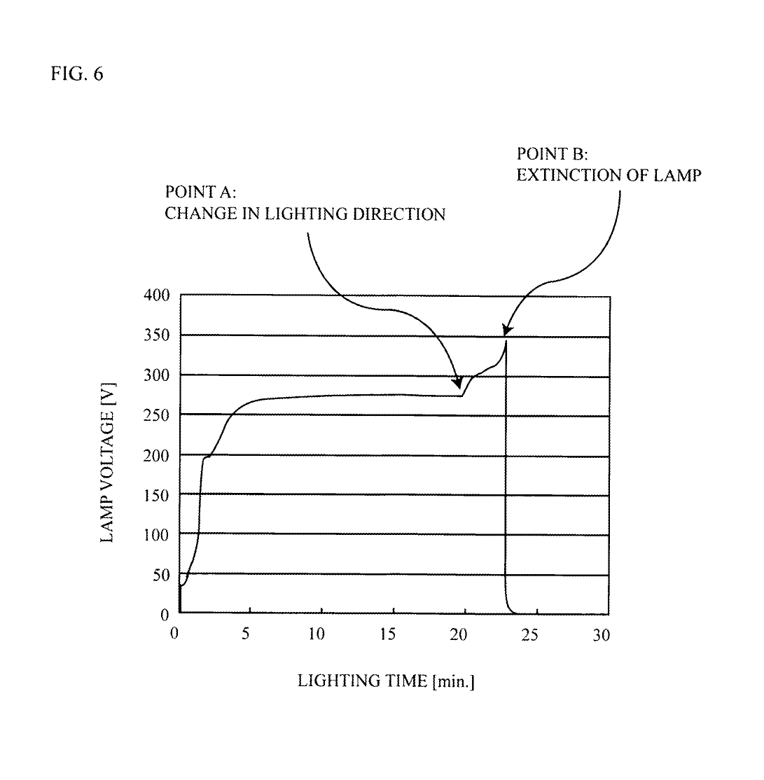

FIG. 6 is a view showing a change in the lamp voltage when the ceramic metal halide lamp shown in FIG. 4 is lighted in a horizontal position. First, the lamp was lighted in a horizontal position while the two arc tubes were arranged side by side along the horizontal direction. In this state, the lamp voltage was stable at about 270 V. Then, the lamp in this state was rotated by an angle of 90 degrees with respect to the tube axis, so that the two arc tubes were arranged side by side along the vertical direction (point A). In this case, the lamp voltage increased rapidly, and the lamp became extinct, when the lamp voltage became approximately 350V (point B). The reason for this is considered as follows: since the two arc tubes were lighted while being arranged side by side along the vertical direction, the upper arc tube was heated by the heat of the lower arc tube, so that the enclosed substance was heated and the internal pressure increased.

If the specification of each arc tube is modified and the lamp voltage is set low, it is possible to avoid the extinction caused by the increase in the lamp voltage when the arc tubes are arranged side by side along the vertical direction. It is, however, impossible to avoid the increase in the temperature of the upper arc tube. The increase in the temperature of the arc tube causes the luminescent color to be changed upon lighting. In this case, the luminescent color differs from a color of a design value. In addition, the respective luminescent colors of the two arc tubes differ from each other, which may cause the color nonuniformity on the irradiated surface.

The heating of the upper arc tube increases its internal pressure, and a heavier load than that upon normal lighting is applied on the discharge vessel. Consequently, the lifetime of the discharge vessel may be shortened by the breakage or degradation thereof.

If one of the arc tubes fails to be lighted, the other cannot be lighted either, because the two arc tubes in this ceramic metal halide lamp are electrically connected in series. Consequently, the ceramic metal halide lamp 21 is not lighted.

In the ceramic metal halide lamp 21 shown in FIG. 4, as long as the two arc tubes are arranged side by side along the horizontal direction, the heat influence from the lower arc tube does not cause any trouble in the upper arc tube.

However, the positions of the two arc tubes cannot be selected, because when the ceramic metal halide lamp 21 is attached to an instrument, it is necessary to screw the base 4 into a socket.

By increasing the distance between the two arc tubes, the heat influence exerted on the other arc tube can be decreased. It is, however, difficult to increase the distance between the two arc tubes. This is because since in a method of manufacturing this ceramic metal halide lamp 21, a stem on which the two arc tubes are mounted is inserted into the molded outer globe 4 and then the outer globe 4 is sealed, it is necessary to make the size of the stem large enough to pass through a neck part 7 of the outer globe while the two arc tubes are arranged side by side.

### Example 1

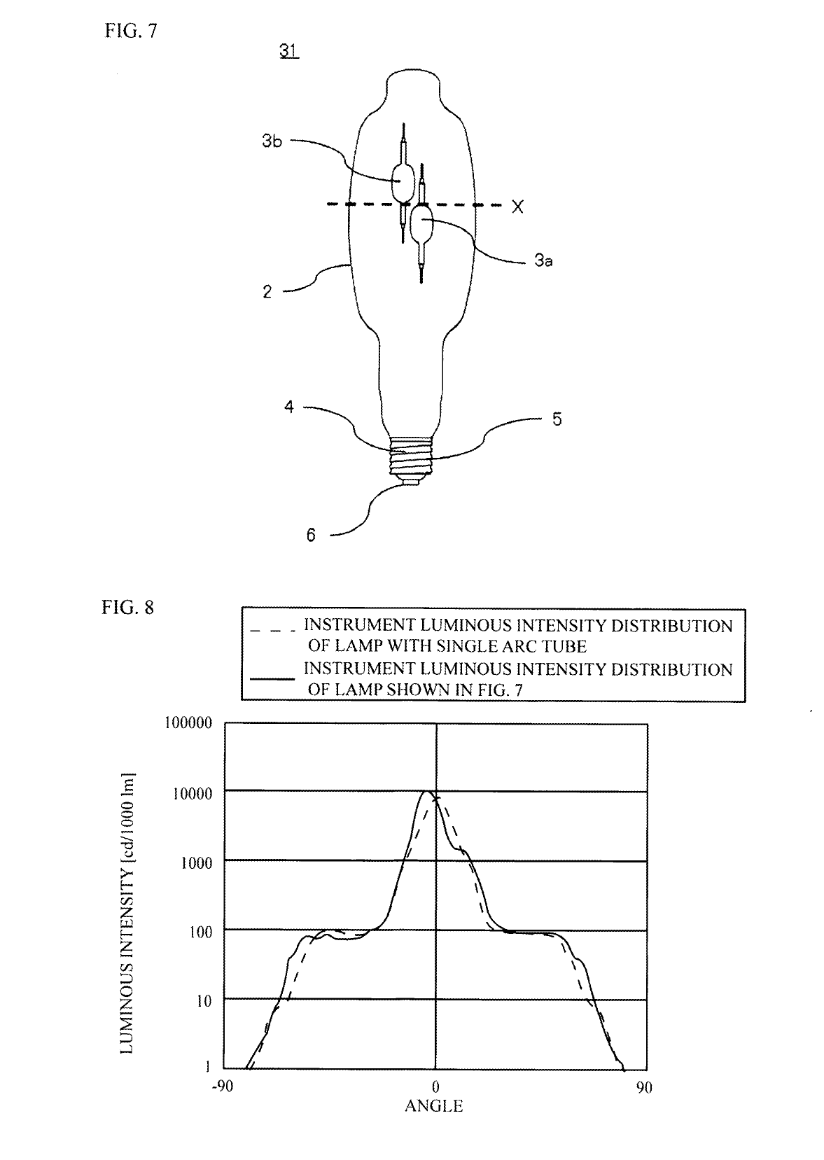

FIG. 7 is a view showing a ceramic metal halide lamp 31 according to a first embodiment of the present invention. Here, the arc tubes disposed on the base side and the lamp top side are denoted by a first arc tube 3a and a second arc tube 3b, respectively. The first arc tube 3a is disposed such that the distance from the base becomes substantially the center of light. In addition, the second arc tube 3b is disposed such that at a location X, the end on the lamp top side of the light-emitting part of the first arc tube 3a is substantially aligned, along the tube axis, with the end on the base side of the light-emitting part of the second arc tube 3b.

FIG. 8 is a result of comparison between a measured instrument luminous intensity distribution on a vertical plane from the light ceramic metal halide lamp 31, shown in FIG. 7, disposed in an illumination instrument and that of a ceramic metal halide lamp having a single arc tube. The ceramic metal halide lamp 31 shown in FIG. 7 exhibits substantially the same instrument luminous intensity distribution as the lamp having a single arc tube. Thus, the ceramic metal halide lamp 31 exhibits an appropriate luminous intensity distribution without any dropout on the irradiated surface.

The ceramic metal halide lamp 31 shown in FIG. 7 was set in a horizontal position, such that a first arc tube and a second arc tube were disposed on the lower and upper sides, respectively. Then, the ceramic metal halide lamp 31 was lighted. In this case, the slight increase in the lamp voltage of the upper arc tube was found, which was considered to be based on the temperature increase. However, none of the extinction, the color nonuniformity caused by the change in the color of the lamp light, and the like occurred. It is preferable that the first arc tube be disposed in the center of the light; however, it is sufficient that the center of the light is positioned between the first and second arc tubes. Alternatively, the second arc tube may be disposed in the center of the light.

### Example 2

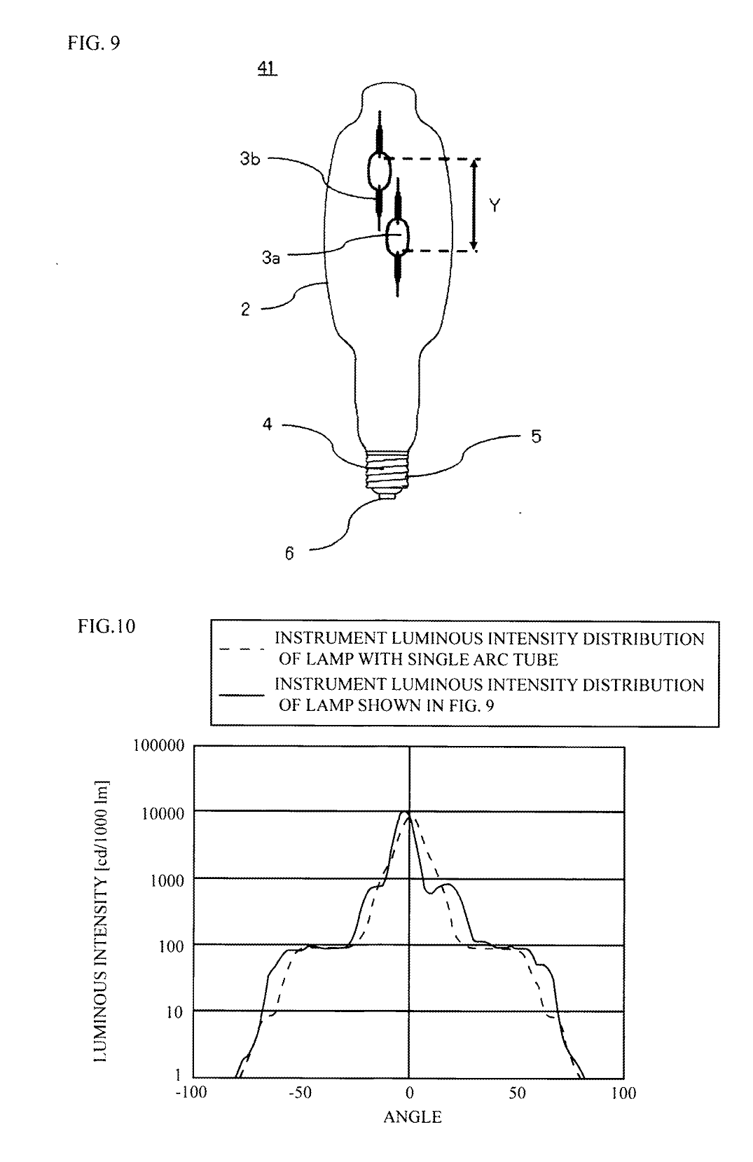

FIG. 9 is a view showing a ceramic metal halide lamp 41 according to a second embodiment of the present invention. Here, arc tubes disposed on the base side and the lamp top side are denoted by a first arc tube 3a and a second arc tube 3b, respectively. The first arc tube 3a is disposed such that the distance from the base becomes substantially the center of light. The second arc tube 3b is disposed such that a distance Y along the tube axis is 3.5 times an average distance between electrodes of the first arc tube 3a and the second arc tube 3b, the distance Y being a distance along the tube axis between the end of the electrode on the lamp top side of the second arc tube 3b and the end of the electrode on the base side of the first arc tube.

FIG. 10 is a result of comparison between a measured instrument luminous intensity distribution on a vertical plane from the ceramic metal halide lamp 41, shown in FIG. 9, disposed in an illumination instrument and that of a ceramic metal halide lamp having a single arc tube. The luminous intensity distribution of the ceramic metal halide lamp 41 was slightly asymmetrical in comparison with that of the lamp having a single arc tube, but none of luminance nonuniformity and dropout considered to be harmful on the irradiated surface was observed. Thus, the ceramic metal halide lamp 41 can sufficiently be used. It is preferable that the first arc tube be disposed in the center of the light; however, it is sufficient that the light center is positioned between the first and second arc tubes. Alternatively, the second arc tube may be disposed in the center of the light.

As explained above, as for a ceramic metal halide lamp such that two arc tubes are electrically connected in series within a single outer globe and are lighted simultaneously, it can be found out from Example 1 and Example 2 that it is possible to solve problems with respect to the heating of the arc tubes or the instrument luminous intensity distribution by setting the distances of the arc tubes along the tube axis so as to fall within a suitable range.

In Example 1, when arc tubes disposed on the base side and the lamp top side are denoted by a first arc tube and a second arc tube, respectively, the end on the lamp top side of the light-emitting part of the first arc tube is disposed closer to the base than the end on the base side of the light-emitting part of the second arc tube. Example 1 demonstrates that even when the temperature of the arc tubes arranged close to each other increases, this arrangement does not cause increase in the lamp voltage to cause the extinction and increase in the thermal load to affect the lifetime.

In Example 2, the distance along the tube axis between the end of the electrode on the base side of a first arc tube and the end of the electrode on the lamp top side of a second arc tube is equal to or less than 3.5 times an average distance between electrodes of the two arc tubes. Example 2 demonstrates that this arrangement prevents the occurrence of problems with respect to the instrument luminous intensity distribution, such as illumination nonuniformity or dropouts, when the lamp is disposed in an instrument. In conclusion, it is found out that it is possible to solve problems with respect to the temperature and the instrument luminous intensity distribution, by setting the distance between two arc tubes to fall within a range between Example 1 and Example 2.

### Example 3

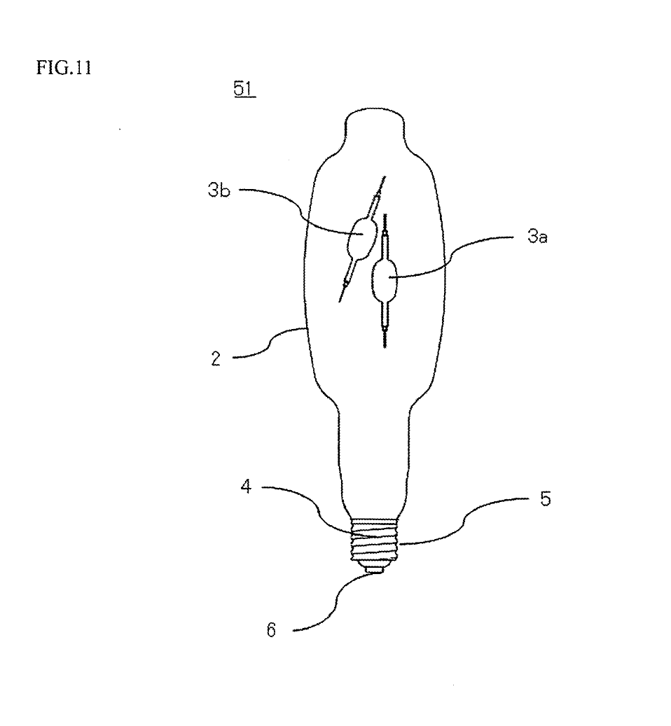

FIG. 11 is a view showing a ceramic metal halide lamp 51 according to a third embodiment of the present invention. Here, the arc tubes disposed on the base side and the lamp top side are denoted by a first arc tube and a second arc tube, respectively. The first arc tube is disposed such that the distance from the base becomes substantially the center of light. The second arc tube is inclined at an angle of 20 degrees with respect to the tube axis, and is disposed at a location where the end on the lamp top side of the light-emitting part of the first arc tube is substantially aligned, along the tube axis, with the end on the base side of the light-emitting part of the second arc tube.

The ceramic metal halide lamp 51 shown in FIG. 11 was set in a horizontal position, such that the first and second arc tubes were disposed on the lower and upper sides, respectively. Then, the ceramic metal halide lamp 31 was lighted. In this case, the slight increase in the lamp voltage of the upper arc tube was found, which is considered to be based on the temperature increase. However, none of the extinction, the color nonuniformity caused by the change in the color of the lamp light, and the like occurred.

As described above, as shown in FIG. 11, two arc tubes are arranged, such that the end on the lamp top side of the light-emitting part of a first arc tube is disposed closer to the base along the tube axis than the end on the base side of the light-emitting part of the second arc tube. Even if an arc tube is disposed while being inclined with respect to the tube axis, this arrangement prevents any problems due to the increase in the temperature of the arc tubes, and enables a lamp to be made compact by inclining the arc tubes with respect to the tube axis.

### REFERENCE SIGNS LIST

1, 21, 31, 41 and 51: ceramic metal halide lamp
2: outer globe
3a and 3b: arc tube
4: base
5: shell
6: eyelet
7: neck part
11: light-emitting part
12: capillary tube part
13: electrode mount
14: electrode
15: intermediate assembly
16: conductive cermet rod
17: external lead
18: stopper
19: reinforcing ring

1. A ceramic metal halide lamp comprising:
two arc tubes provided in a single outer globe, each of the arc tubes having a pair of electrodes therein, the two arc tubes being electrically connected in series and lighted simultaneously,
wherein when the arc tubes disposed on a base side and a lamp top side are denoted by a first arc tube and a second arc tube, respectively, an end on the lamp top side of a light-emitting part of the first arc tube is disposed closer to a base along a lamp tube axis than an end on the base side of a light-emitting part of the second arc tube, and
a distance along the lamp tube axis between an end of the electrode on the base side of the first arc tube and an end of the electrode on the lamp top side of the second arc tube is equal to or less than 3.5 times an average distance between electrodes of the first and second arc tubes.

2. The ceramic metal halide lamp according to claim 1, wherein the two arc tubes are arranged substantially parallel to the tube axis.

3. The ceramic metal halide lamp according to claim 2, wherein the first arc tube is disposed in a center of lamp light.

4. The ceramic metal halide lamp according to claim 1, wherein the first arc tube is disposed substantially parallel to the tube axis, and the second arc tube is disposed while being inclined with respect to the tube axis.

5. The ceramic metal halide lamp according to claim 4, wherein the first arc tube is disposed in a center of lamp light.
